(19) United States
(12) Patent Application Publication
(10) Pub. No.: US 2026/0113513 A1
(43) Pub. Date: Apr. 23, 2026

(54) INFORMATION-PROCESSING APPARATUS, INFORMATION-PROCESSING METHOD, AND PROGRAM

(71) Applicant: Sony Group Corporation, Tokyo (JP)

(72) Inventors: Masayuki INOUE, Chiba (JP); Yuto YOKOYAMA, Saitama (JP); Yukio YAKUSHIJIN, Tokyo (JP)

(73) Assignee: Sony Group Corporation, Tokyo (JP)

(21) Appl. No.: 19/117,642

(22) PCT Filed: Oct. 31, 2023
(86) PCT No.: PCT/JP2023/039337

§ 371 Date: Apr. 2, 2025

(30) Foreign Application Priority Data
Feb. 10, 2023 (JP) 2023-019005

(51) Int. Cl. H04N 21/81; G06T 19/00; H04N 21/235; H04N 21/43; H04N 21/435

(52) U.S. Cl. CPC H04N 21/816; G06T 19/00; H04N 21/2353; H04N 21/4307; H04N 21/435; G06T 2210/32

(57) ABSTRACT

There is provided an information processing apparatus including circuitry configured to receive, from a first apparatus, motion data captured in an event, receive, from a second apparatus, event metadata related to the event, and transmit the motion data and the event metadata to a user apparatus.

### CROSS REFERENCE TO RELATED APPLICATIONS

This application claims the benefit of Japanese Priority Patent Application JP 2023-019005 filed on Feb. 10, 2023, the entire contents of which are incorporated herein by reference.

### TECHNICAL FIELD

The present disclosure relates to an information-processing apparatus, an information-processing method, and a program.

### BACKGROUND ART

Recently, an image-analysis technique has been improved. For example, a motion capture technique for extracting a human skeleton position (a plurality of points corresponding to each respective parts of a body, such as a head, a torso, and limbs and the like) from a captured image and recording a change in the skeleton position as human motion is known.

In recent years, such an image-analysis technology has been used in sporting events and the like; a captured image obtained by imaging a player is analyzed in real time to determine whether a specific event has occurred in the captured image or not. Also, when a large number of objects (players) are included in a captured image, a processing load of image analysis increases. Therefore, for example, in Patent Document 1 below, a more efficient image-processing technology is implemented by selecting a part of the captured image and analyzing an image smaller than the original image.

### CITATION LIST

### Patent Literature

PTL 1: US Patent Application Publication No. 2020/0151881 Specification

### SUMMARY

### Technical Problem

Here, it is also possible to move a virtual object (for example, an avatar generated using 3DCG) in a virtual space on the basis of motion data that is motion information extracted and recorded from the captured image. However, it is not assumed that data different from the motion data is used together when implementing display control of the virtual object.

Therefore, the present disclosure proposes an information-processing apparatus, an information-processing method, and a program capable of obtaining and transmitting each of target motion data and event metadata during an event.

### Solution to Problem

According to an aspect of the present disclosure, there is provided an information processing apparatus including: circuitry configured to: receive, from a first apparatus, motion data captured in an event; receive, from a second apparatus, event metadata related to the event; and transmit the motion data and the event metadata to a user apparatus.

Further, according to another aspect of the present disclosure there is provided an information processing method including: receiving, from a first apparatus, motion data captured in an event; receiving, from a second apparatus, event metadata related to the event; and transmitting the motion data and the event metadata to a user apparatus.

Further, according to another aspect of the present disclosure there is provided a nontransitory computer-readable medium having embodied thereon a program, which when executed by a computer causes the computer to execute an information processing method, the method including: receiving, from a first apparatus, motion data captured in an event; receiving, from a second apparatus, event metadata related to the event; and transmitting the motion data and the event metadata to a user apparatus.

Further, according to another aspect of the present disclosure there is provided an information processing system including: circuitry configured to receive, from a first apparatus, motion data captured in an event, receive, from a second apparatus, event metadata related to the event, initiate a displaying of a virtual object on a display, based on the motion data, and initiate a displaying of information on the display, based on the event metadata.

Further, according to another aspect of the present disclosure there is provided information displayed on a screen including motion data captured in an event and event metadata related to the event displayed on the screen, wherein the motion data and event metadata are generated by receiving the motion data and the event metadata from an information processing apparatus that receives the motion data from a first apparatus and receives the event metadata from a second apparatus.

### BRIEF DESCRIPTION OF DRAWINGS

FIG. 1 is a diagram illustrating a configuration of an information-processing system 1A according to a first embodiment.

FIG. 2 is a block diagram showing an example of a configuration of a server 20A according to the first embodiment.

FIG. 3 is a sequence diagram illustrating a flow of operation processing in the information-processing system 1A according to the first embodiment.

FIG. 4 is a diagram illustrating a configuration of an information-processing system 1B according to a second embodiment.

FIG. 5 is a block diagram illustrating an example of a configuration of a server 20B according to the second embodiment.

FIG. 6 is a sequence diagram illustrating a flow of operation processing in the information-processing system 1B according to the second embodiment.

FIG. 7 is a view illustrating an example of a highlight-metadata creation screen according to the second embodiment.

FIG. 8 is a block diagram illustrating a hardware configuration example of an information-processing apparatus 900.

### DESCRIPTION OF EMBODIMENTS

Hereinafter, embodiments of the present disclosure will be described in detail with reference to the accompanying drawings. Note that in the present specification and drawings, components having substantially the same functional configuration are denoted using the same reference numerals. Redundant explanations are therefore omitted.

Furthermore, the description is given in the following order.
1. First Embodiment
1-1. System Configuration
1-2. Server 20A Configuration
1-3. Operation Processing
2. Second Embodiment
2-1. System Configuration
2-2. Server 20B Configuration
2-3. Operation Processing
2-4. Highlight-metadata Creation Screen
3. Modification Examples
4. Hardware Configuration
5. Supplement

### 1. First Embodiment

The information-processing system according to the first embodiment of the present disclosure will now be described in detail with reference to the drawings.

### 1-1. Configuration of Information-Processing System 1A

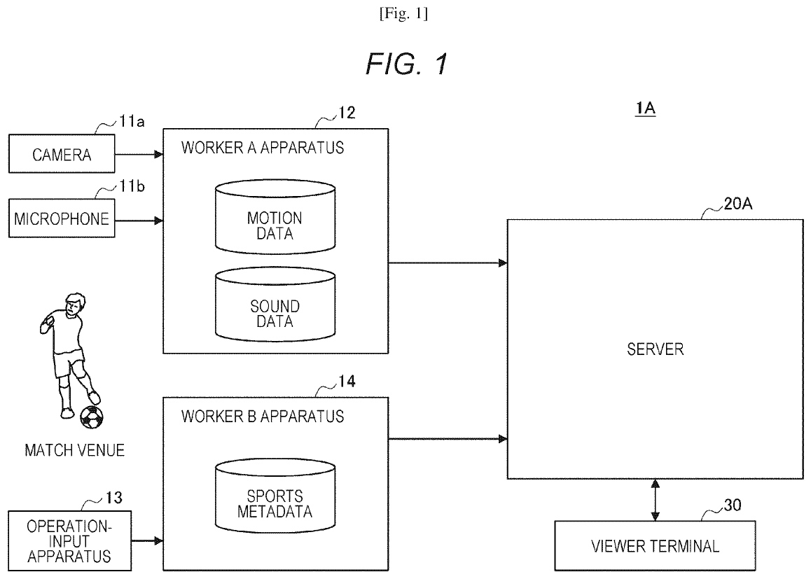

FIG. 1 is a diagram illustrating a configuration of an information-processing system 1A according to a first embodiment. As illustrated in FIG. 1, the information-processing system 1A includes a worker A apparatus 12 (an example of a first apparatus), a worker B apparatus 14 (an example of a second apparatus), a server 20A (an example of an information-processing apparatus), and a viewer terminal 30 (an example of a user terminal).

The worker A apparatus 12 is an apparatus used by worker A. The worker A apparatus 12 obtains motion data by tracking a motion of a target during an event. An example of an event includes a sporting match. More specifically, an embodiment of the present disclosure will be described assuming a soccer match. In such a case, the tracking target includes a player and a ball. Furthermore, the tracking of the motion of the target is specifically a tracking of a position and a height of the ball obtained by analyzing the captured image, and a tracking of the position and height of the player and the position of each skeleton of the player obtained by analyzing the captured image.

The worker A apparatus 12 obtains, for example, a captured image (hereinafter, also referred to as a match video) obtained by capturing an image of a soccer match from a camera 11a. A large number of cameras 11a are arranged in the match venue, and the worker A apparatus 12 obtains match video from various locations and angles. The worker A apparatus 12 analyzes the match video and obtains motion data of players and the ball during the match.

An example of a data structure of the motion data is illustrated in Table 1 below.

TABLE 1

| Category | Item |
|---|---|
| Ball | Position (Position) |
| | Height Of Ground (Height from ground to ball position) |
| Player | Track ID (Tracking ID) |
| | Joint IDs (Information array of bone IDs) |
| | Positions (Position information of each bone) |
| | Transformations (Position, rotation, scale of each bone) |
| | Hight Of Ground (Height from ground to player's position) |
| | Skeleton Type (Skeleton type) |
| | Team ID (Player's team ID) |
| | Role ID (Role of player; goal keeper, other than goal |
| | keeper, referee) |
| | Jersey Number (Player's jersey number) |
| Other | Version (Data version information) |
| | Time (Absolute time of data) |

As shown in Table 1 above, the motion data includes ball data, player data, and other data. Furthermore, among the data included in the motion data, the ball position information, the height information of the ball position from the ground, the three-dimensional skeleton position data of each player, the height information of the player position from the ground, and the like are respectively time-series data arranged in time series with reference to an absolute time of the data. The “absolute time of the data” is an elapsed time from a predetermined starting point. In an embodiment of the present disclosure, an elapsed time from Jan. 1, 2000 using the western calendar is assumed as an example of the reference time of such motion data. Hereinafter, this is referred to as “motion reference time.”

The player position information included in the motion data is not limited to the skeleton position data. For example, it may be joint position data indicating a position of a joint. The motion data may further include specific information of the match (which team's match occurred and at what time).

Note that each piece of information included in the motion data is an example. Embodiments of the present disclosure are not limited thereto. It is also possible for an operator manually to correct a missing or damaged portion of the motion data.

In addition, the worker A apparatus 12 may acquire environmental sound data (spectators cheers or the like) of the match venue from a plurality of microphones (microphones) 11b installed at the match venue. The worker A apparatus 12 appropriately adjusts the environmental sound data (noise removal, volume adjustments or the like) to generate sound data. Adjustments of the environmental sound data may be automatically implemented by the worker A apparatus 12 or it may be manually implemented by an operator.

The worker A apparatus 12 transmits the motion data and the sound data of the match to the server 20A, for example, after the match.

The worker B apparatus 14 is an apparatus used by worker B and is different from worker A. The worker B apparatus 14 generates sport metadata including at least timeseries data related to the situation of sports match such as soccer or the like on the basis of information inputted by the operator in the operation-input apparatus 13. The sport metadata is an example of the event metadata.

The data structure of the sport metadata includes information regarding a match start date and time, information regarding an occurrence event and an event occurrence time in a match (time-series data), and information relating to a player.

For example, while watching a match video in real time, the operator inputs the occurrence event in the match from the operation-input apparatus 13 (for example, a PC). Examples of an occurrence event in a match include a score (which team scored and how many points, which players scored goals?), various warnings (In the case of soccer, of yellow card or red card, a violation, or the like) by a referee, a free kick, a player change, and others. The worker B apparatus 14 generates the sport metadata, for example, using the input time of the occurrence event as the event occurrence time. Also, information regarding the event occurrence time may be inputted by an operator. Note that the time information used in the sport metadata according to an embodiment of the present disclosure is assumed to be the date and time in the western calendar.

Also, the information relating to the player is, for example, the players name, their jersey number, their role (goal keeper, other than goal keeper, referee), their affiliated team ID, and other information. The information relating to the player may also be inputted by the worker.

The information included in the sports metadata described above is an example. Embodiments of the present disclosure are not limited thereto.

The sport metadata generated in real time can be variously utilized such as by being distributed from the worker B apparatus 14 to a predetermined distribution destination. In an embodiment of the present disclosure, the sport metadata of the match is transmitted from the worker B apparatus 14 to the server 20A after the match.

The server 20A acquires motion data and sound data from the worker A apparatus 12, and acquires sports metadata from the worker B apparatus 14. Then, the server 20A transmits (distributes) the motion data, the sound data, and the sport metadata to the viewer terminal 30. The transmission format is not particularly limited, but from the viewpoint of the data capacity, for example, the worker A apparatus 12 may cause the viewer terminal 30 to download the sport metadata before viewing, and stream the motion data and the sound data. Furthermore, the motion data and the sound data may be data converted into a distribution format described below, at the server 20A.

The viewer terminal 30 is used by a viewer. The viewer terminal 30 is an example of a user terminal having a function that displays a video of a virtual space. Specifically, the viewer terminal 30 displays (renders) a 3DCG video in the virtual space by using the motion data (the skeleton data of the player, and the ball position, and the like) received from the server 20A and 3D models of the player and the ball received in advance. The viewer terminal 30 can also switch a position of a virtual camera according to a viewer operation. By virtualizing a match performed in the real world, a viewer can arbitrarily switch and view the match from various viewpoints or operate their avatar arranged in a field to view the match from a free viewpoint.

3D models of players and the ball can be acquired in advance from the server 20A or the like. As a result, the viewer terminal 30 can implement reproduction with a lower load than that of receiving and reproducing the 3DCG video in the virtual space in real time.

Furthermore, the viewer terminal 30 can perform display control based on the sport metadata (an example of the event metadata) on the display screen on which the 3DCG (an example of the virtual object) of the player and the ball is displayed. The sport metadata includes, for example, score information, referee warning information, player substitution information, and the like, and the viewer terminal 30 displays the score information regarding the display screen, the warning information, or the player substitution information according to the elapsed time from the start of the match. As a result, the viewer can recognize the status of the match while viewing the 3DCG of the player and the ball. Also, the sport metadata also includes each player's name, and the viewer terminal 30 may perform display control such that the player's name follows the vicinity of the 3DCG of the player. As a result, the viewer can easily identify players.

As described above, in the information-processing system 1A according to an embodiment of the present disclosure, it is possible to provide virtualization of a match performed in the real world in the viewer terminal 30 on the basis of motion data obtained from a match video and 3D models of the players and ball. Furthermore, at the time of virtualizing a match, the information-processing system 1A can recognize a situation or the like of the match by using together sports metadata that is data from an acquisition source different from an acquisition source of motion data. The sport metadata may be data generated by an apparatus that is different from the apparatus that generated the motion data. Also, it is assumed that the sport metadata is data of a right holder who is different from the right holder of the motion data.

### 1-2. Server 20A Configuration

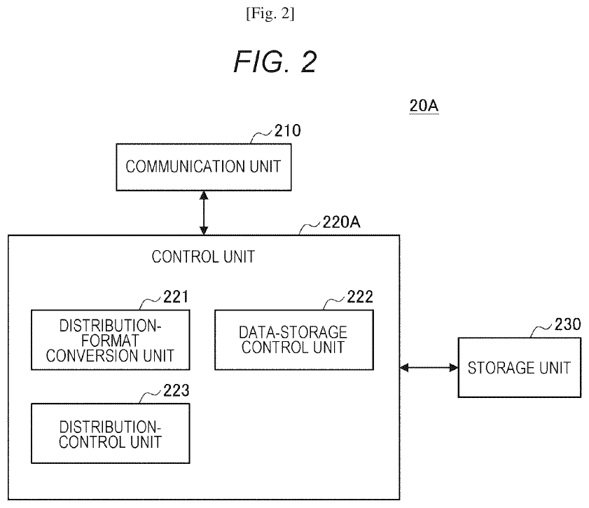

FIG. 2 is a block diagram showing an example of a configuration of the server 20A according to the first embodiment. As shown in FIG. 2, the server 20A includes a communication unit 210, a control unit 220A, and a storage unit 230.

### (Communication Unit 210)

The communication unit 210 includes a transmission unit that transmits data to an external apparatus and a reception unit that receives data from the external apparatus. The communication unit 210 according to an embodiment of the present disclosure may be communicably connected to an external apparatus or to the Internet, using, for example, a wired/wireless local area network (LAN), a Wi-Fi (registered trademark), a Bluetooth (registered trademark), a mobile communication network (Long Term Evolution (LTE)), fourth generation mobile communication system (4G), or fifth generation mobile communication system (5G)), or the like.

The communication unit 210 receives motion data and sound data from the worker A apparatus 12. Also, the communication unit 210 receives the sport metadata from the worker B apparatus 14. Also, the communication unit 210 transmits each of the motion data, the sound data, and the sport metadata to the viewer terminal 30. Note that the motion data and the sound data may be data converted into a distribution format described below.

### (Control Unit 220A)

The control unit 220A functions as an arithmetic processing unit and a control unit, and controls an overall operation in the server 20A in accordance with various programs. The control unit 220A is implemented by an electronic circuit such as a central processing unit (CPU) or a microprocessor or the like, for example. Also, the control unit 220A may include a read-only memory (ROM) that stores programs, and operation parameters, and the like to be used, and a random-access memory (RAM) that temporarily stores parameters and the like that change appropriately.

Also, the control unit 220A also functions as a distribution-format conversion unit 221, a data-storage control unit 222, and a distribution-control unit 223.

The distribution-format conversion unit 221 converts the motion data and the sound data into a distribution format. The distribution format may be, for example, MPEG-DASH. Here, the reference time (motion reference time) used for motion data assumes the elapsed time from Jan. 1, 2000 using the western calendar as described above. However, when converted to a distribution format, a reference time (hereinafter, also referred to as a format reference time) used in the distribution format is newly given. The reference time used for the distribution format is an elapsed time from the beginning of the motion data (time-series data). In the case of MPEG-DASH, the format reference time is also referred to as an MPEG-DASH time. Note that in a case where there is sound data, it may be assumed that the beginning of the sound data is at the same timing as the beginning of the motion data. For example, in a case where the sound data and the motion data are data in which sound collection and imaging were started at the same timing in a match venue, the beginning of the sound data and the motion data are at the same timing. Also, the sound data and the motion data may be automatically or manually aligned at the beginning by sound matching or the like at the worker A apparatus 12.

The data-storage control unit 222 performs control to store the data converted into the distribution format and the sport metadata in the storage unit 230. The data converted into the distribution format and the sport metadata are also referred to as content data. Note that the data-storage control unit 222 may acquire the sports metadata of the match from the worker B apparatus 14 on the basis of the match-specification information included in the motion data, and store the acquired sports metadata in the storage unit 230 in association with the data converted into the distribution format.

The distribution-control unit 223 performs control to distribute the data converted into the distribution format and the sport metadata. For example, the distribution-control unit 223 transmits the sport metadata to the viewer terminal 30 that has made the distribution request in a download format, or transmits data (motion data and sound data) converted into a distribution format in a streaming format. The transmission of the sport metadata may be performed before the start of streaming.

### (Storage Unit 230)

The storage unit 230 is implemented by a ROM that stores programs, operation parameters, and the like used for processing of the control unit 220A, and a RAM that temporarily stores parameters and the like that change as appropriate. For example, the data converted into the distribution format and the corresponding sport metadata are also stored as content data in the storage unit 230.

The configuration of the server 20A was described in detail, but the configuration of the server 20A in this disclosure is not limited to the example shown in FIG. 2. For example, the server 20A may be implemented using a plurality of apparatuses.

### 1-3. Operation Processing

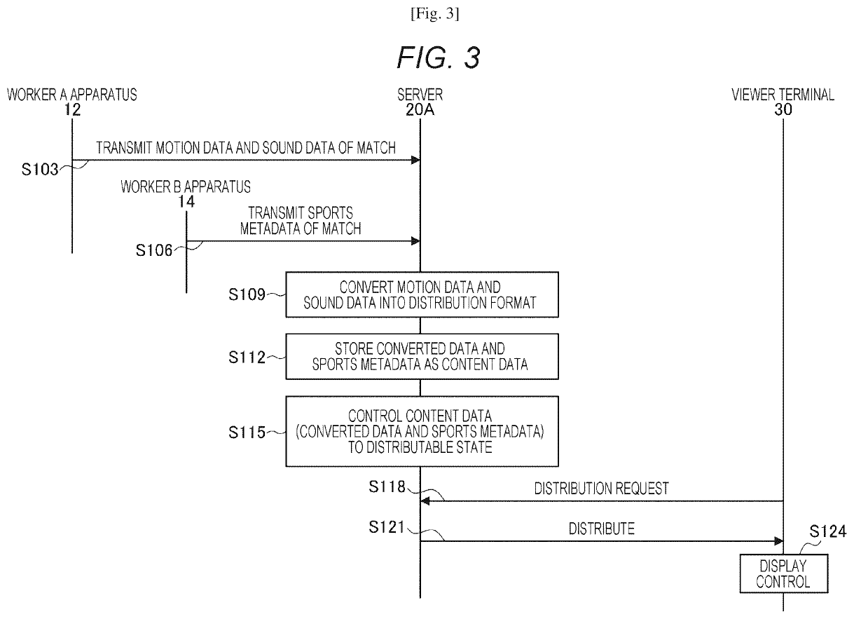

FIG. 3 is a sequence diagram illustrating a flow of operation processing in the information-processing system 1A according to the first embodiment.

As shown in FIG. 3, the worker A apparatus 12 transmits the motion data and the sound data of the match to the server 20A (Step S103).

Next, the worker B apparatus 14 transmits the sport metadata of the match to the server 20A (Step S106).

Next, the server 20A converts the motion data and the sound data into a distribution format (Step S109).

Next, the server 20A stores the converted data and the sport metadata of the match in the storage unit 230 as content data (Step S112).

Next, the server 20A controls the content data to be in a distributable state (Step S115). The distributable state is a state in which the viewer terminal 30 is notified that the content data can be distributed, and distribution can be started in response to a distribution request from the viewer terminal 30. The viewer operates the viewer terminal 30 to check a list of distributable content data, and can make a distribution request of arbitrary content data (For example, a particular match).

Subsequently, the server 20A distributes the content data in response to the distribution request (Step S118) from the viewer terminal 30 (Step S121). Specifically, the server 20A causes the viewer terminal 30 to download the sport metadata, and then distributes the converted data (motion data and sound data) as a stream to the viewer terminal 30.

Then, the viewer terminal 30 implements display control on the basis of the received data (Step S124). Specifically, the viewer terminal 30 arranges a 3D model of a player, a 3D model of a ball, and the like obtained in advance in a virtual space (for example, a space obtained by virtually reproducing a match venue in a real space), and implements processing to generate a 3DCG video of the virtual space by moving the 3D model on the basis of motion data (skeleton position data of each player, position data of the ball, and the like). Also, the viewer terminal 30 starts reproduction of the sound data along with the start of the display control of the 3DCG video of the virtual space. Furthermore, the viewer terminal 30 displays the score information or the like on the basis of the sport metadata in addition to the display control of the 3DCG video of the virtual space.

Furthermore, the viewer terminal 30 may also synchronize the sport metadata and the motion data in the display control illustrated in the Step S124. As described above, it is assumed that the motion data and the sport metadata have different rights holders, and the motion data and the sport metadata have different specifications of data such as a data structure and a reference time and the like to be used. In this case, it is difficult appropriately to reproduce in the virtual space based on the motion data and the sport metadata, and a temporal difference may occur. Therefore, the viewer terminal 30 can appropriately reproduce in the virtual space by synchronizing the motion data with the sport metadata.

For example, the viewer terminal 30 calculates the match start timing in the motion data on the basis of the match start date and time information (the date and time of the western calendar) included in the sport metadata, and displays the score information or the like on the display screen according to the elapsed time from the match start timing. More specifically, the viewer terminal 30 can convert the date and time information (western calendar) of the match start into an elapsed time from Jan. 1, 2000 which is a reference time (motion reference time) used for the motion data, and determine the match-start timing in the motion data on the basis of the conversion time.

Then, the viewer terminal 30 converts the match-start timing of the motion reference time into an elapsed time from the beginning of data, which is a reference time (format reference time) used in the distribution format. It is assumed that the motion data is obtained from timing before the start of the match (for example, several minutes or the like before the kickoff). As described above, the viewer terminal 30 can synchronize the sports metadata and the motion data with reference to the match-start timing, display the 3DCG of each player and the ball on the basis of the match motion data, and display the score information at the timing when a score is obtained during the match, etc.

Note that the synchronization method described above is an example; embodiments are not limited thereto. Also, the synchronization process is implemented in advance in the server 20A, and information regarding the match-start timing (elapsed time from the beginning) in the motion data may be provided to the viewer terminal 30.

The first embodiment according to an aspect of the present disclosure has been described above.

### 2. Second Embodiment

The information-processing system according to the second embodiment of this disclosure will now be described in detail with reference to the drawings. In the first embodiment described above, the display control of the virtual space is implemented according to the motion data of the full time match, but the present disclosure is not limited thereto. For example, it is also conceivable to implement highlight reproduction for performing display control of the virtual space on the basis of motion data corresponding to each highlight scene using information indicating the time (position on the time axis) of the highlight scene. The second embodiment that enables such highlight reproduction will be described.

### 2-1. System Configuration

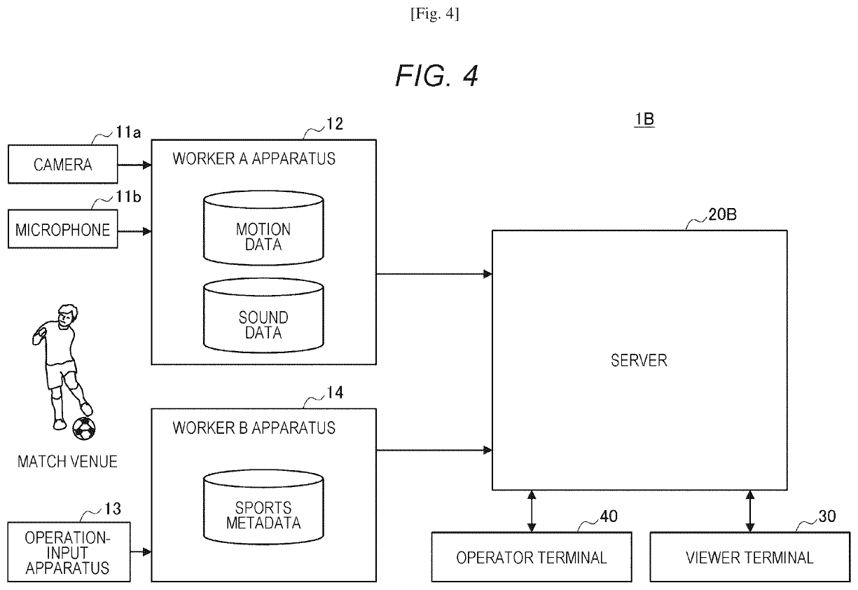

FIG. 4 is a diagram illustrating a configuration of an information-processing system 1B according to the second embodiment. As shown in FIG. 4, the information-processing system 1B includes a worker A apparatus 12 (an example of a first apparatus), a worker B apparatus 14 (an example of a second apparatus), a server 20B (an example of an information-processing apparatus), and a viewer terminal 30 (an example of a user terminal), and an operator terminal 40.

In addition to the configuration of the information-processing system 1A described with reference to FIG. 1, the information-processing system 1B has an operator terminal 40 that is used by a service operator and that generates highlight metadata. The service operator is a worker who is different from the worker A and the worker B, and may be a worker that supplies a viewing application provided to the viewer terminal 30. Furthermore, the service operator may be a worker (team worker) of a team based on the match venue where the match was held. The team worker can implement the virtualization of the match (the match in which the team belongs to the home) played in a field of the team worker using a dedicated application for providing the match to the fans of the team.

In the operator terminal 40, the highlight metadata indicating the time information of the highlight scene in the motion data is generated on the basis of the time information of each highlight scene created when the highlight 2D video of the match is generated on the basis of the 2D video of the match (video obtained by capturing the match with a camera). The time information of the highlight scene is information indicating an IN point and an OUT point of each highlight scene. The IN point and the OUT point are indicated by elapsed times from the beginning of the 2D video. Furthermore, the time information of the highlight scene in the motion data is information indicating the scene-reproduction start time and the scene duration time of each highlight scene in the motion data. The scene-reproduction start time is indicated by an elapsed time from the beginning of the (format-converted) motion data.

An editor application (hereinafter, also referred to as editor AP) for creating highlight content is downloaded to the operator terminal 40. The service operator can generate highlight metadata by operating the highlight-metadata creation screen displayed by the editor AP. The operator terminal 40 transmits the highlight metadata to the server 20B. Note that the editor AP may operate in the server 20B and provide the highlight-metadata creation screen to the operator terminal 40 as a web browser.

The server 20B transmits the highlight metadata received from the operator terminal 40 and the content data to the viewer terminal 30. As a result, when performing display control of the virtual space on the basis of the motion data, the viewer terminal 30 can implement display control of only each highlight scene using the highlight metadata. The viewer can sequentially view only the exciting scenes in the match (for example, scoring scenes) in the virtual space.

### 2-2. Server 20B Configuration

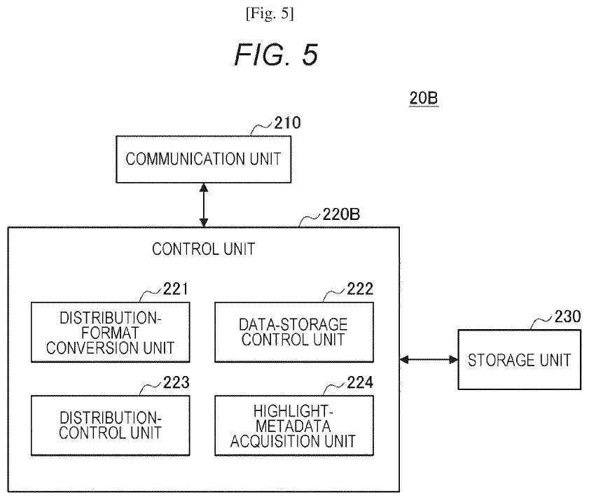

FIG. 5 is a block diagram showing an example of a configuration of the server 20B according to the second embodiment. As shown in FIG. 5, the server 20B includes a communication unit 210, a control unit 220B, and a storage unit 230. The communication unit 210 and the storage unit 230 are as described above with reference to FIG. 2.

Also, the control unit 220B also functions as a distribution-format conversion unit 221, a data-storage control unit 222, a distribution-control unit 223, and a highlight-metadata acquisition unit 224. The functions of the distribution-format conversion unit 221, the data-storage control unit 222, and the distribution-control unit 223 are as described in reference to FIG. 2.

The highlight-metadata acquisition unit 224 performs control to acquire highlight metadata. The highlight-metadata acquisition unit 224 transmits data for generating the highlight metadata from the communication unit 210 to the operator terminal 40, and receives the highlight metadata from the operator terminal 40. The highlight-metadata acquisition unit 224 transmits, for example, the motion data (format converted) and the sport metadata stored in the storage unit 230 to the operator terminal 40 as data for generating the highlight metadata. Also, the highlight-metadata acquisition unit 224 may transmit, for example, motion data, sound data (format converted), and sport metadata to the operator terminal 40 as data for generating the highlight metadata.

The configuration of the server 20B was described in detail, but the server 20B configuration in this disclosure is not limited to the example shown in FIG. 5. For example, the server 20B may be implemented using a plurality of apparatuses.

### 2-3. Operation Processing

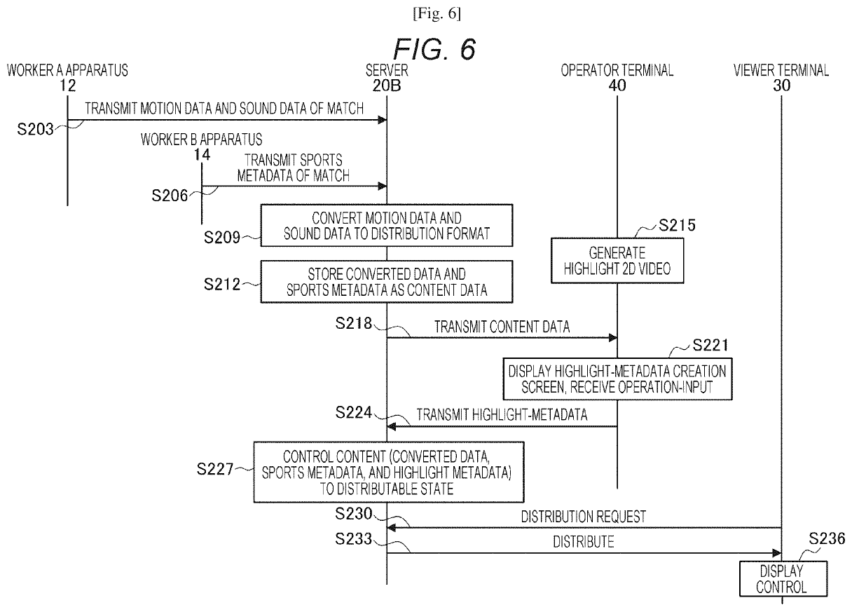

FIG. 6 is a sequence diagram illustrating a flow of operation processing in the information-processing system 1B according to the second embodiment.

Because the processing from Steps S203 to S212 illustrated in FIG. 6 is similar to Steps S103 to S112 in FIG. 3, a description thereof will be omitted.

Next, in the operator terminal 40, the highlight 2D video of the match is generated on the basis of the 2D video of the match (Step S215). The highlight 2D video may be generated by automatically or manually extracting a scoring scene from the match video, for example. At this time, time information (IN point information, OUT point information) of the extracted scene, that is, the highlight scene is also generated.

Next, the server 20B transmits content data (at least motion data and sport metadata of the match) to the operator terminal 40 (Step S218).

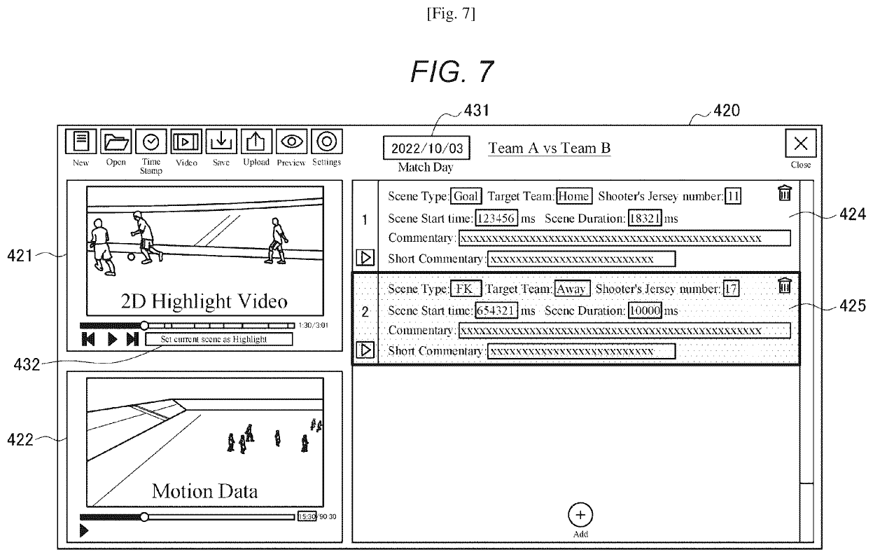

Next, the operator terminal 40 displays a highlight-metadata creation screen and receives an operation input of the service operator (Step S221). On the highlight-metadata creation screen, a display screen of a highlight 2D video (a captured image of a match performed in the real space), a display screen (virtual video) of a player 3DCG or the like based on motion data, and an input screen for inputting metadata of each highlight scene are displayed. At least time information (scene reproduction start time and a scene duration time) of each highlight scene is inputted on the screen for inputting metadata of each highlight scene. Details of the highlight-metadata creation screen will be described later with reference to FIG. 7.

Next, the operator terminal 40 transmits the highlight metadata to the server 20B (Step S224).

Next, the server 20B controls the content data (including the highlight metadata) to be put into a distributable state (Step S227).

Next, the server 20B distributes the content data (including the highlight metadata) (Step S233) in response to the distribution request (Step S230) from the viewer terminal 30. Specifically, the server 20B transmits sport metadata, highlight metadata, and format-converted data (motion data and sound data) to the viewer terminal 30.

Then, the viewer terminal 30 implements display control on the basis of the received data (Step S236). Specifically, the viewer terminal 30 implements a process of arranging a 3D model of a player, a 3D model of a ball, and the like obtained in advance, in a virtual space (for example, a space obtained by virtually reproducing a match venue in a real space) and generating a 3DCG video of the virtual space by moving the 3D models on the basis of motion data (3D skeleton position data of each player, position data of the ball, and the like). At this time, the viewer terminal 30 performs display control of the virtual space based on the motion data on the basis of the highlight metadata (including information of the scene reproduction start time and the scene duration time represented by the motion reference time).

Because the motion data is data of a temporal length including at least the entire match, the viewer terminal 30 can reproduce all the highlight scenes by repeatedly displaying (reproducing) the virtual space on the basis of the motion data from the scene reproduction start time included in the highlight metadata among the motion data, reproducing to the end point of the scene (the timing when the scene duration time has elapsed from the scene reproduction start time), and then seeking and reproducing at the reproduction point of the next scene (the scene reproduction start time). Note that the motion reference time (expression based on the elapsed time from the beginning of the motion data) is used in the reference time of the highlight metadata.

The configuration of the operation processing according to the second embodiment has been described in detail above. Note that the operation processes shown in FIG. 6 are examples. The present disclosure is not limited thereto. For example, the server 30B may sequentially stream-distribute the motion data of the highlight scene among the motion data on the basis of the highlight metadata. In this case, the viewer terminal 30 can generate the 3DCG video of the highlight scene by moving the 3D model of the player, the 3D model of the ball, and the like received in advance, according to the received motion data.

### <2-4. Highlight-Metadata Creation Screen

FIG. 7 is a view illustrating an example of a highlight-metadata creation screen according to the second embodiment. As shown in FIG. 7, a display screen 421 of a highlight 2D video, a display screen 422 displaying a player 3DCG or the like rendered on the basis of motion data, and an input screen (a first scene-input screen 424, and a second scene-input screen 425) for inputting metadata of each highlight scene are displayed on the highlight-metadata creation screen 420.

The operator terminal 40 displays the highlight 2D video generated in advance on the display screen 421. The operator (service operator) inputs each type of highlight metadata from the input screen while confirming the display screen 422 on which is displayed the 3DCG and the like of the player rendered on the basis of motion data, on the basis of each highlight scene reproduced on the display screen 421.

Firstly, the operator of the operator terminal 40 inputs the date of the target match in the date-input field 431 displayed at a top portion of the highlight-metadata creation screen 420. Because the sport metadata received by the operator terminal 40 from the server 20A includes the information of the date and the competing teams of the match, the operator terminal 40 displays the information of the corresponding competing team next to the date-input field 431.

When the operator visually recognizes the highlight 2D video displayed on the display screen 421 and selects a setting button 432 displayed below the seek bar at a reproduction position of the scene for which the highlight metadata of the motion data is desired to be created, the input screen of the highlight metadata (for example, the input screen 425 of the second scene) is displayed.

On the input screen, for example, a scene type (a scoring scene, a free kick scene, and the like), a target team (home, or away), a jersey number of a player who made the last shot, a scene-reproduction start time, a scene-duration time, a scene-description sentence, and a short version of the scene description can be inputted. The items described here are an example; this embodiment is not limited to this.

The scene type is information used when displaying an icon indicating which scene it is, in the chapter list displayed when viewing. For example, in the case of a scoring scene, an icon of the goal post is displayed. Furthermore, in the chapter list, a short version of the scene description can also be displayed next to the icon.

The target team is information indicating whether the team on the opposing side in each scene is a home team or an away team. The home team is a team on the side based at the match venue, and in an embodiment of the present disclosure, a competition between the home team and the away team is assumed. Also, which team that is competing is the home team, and which is the away team, may be included in the motion data or the sports metadata. When viewing each highlight scene, for example, a cover screen indicating the logo of the target team of the scene is displayed, and the target team is used at that time. The number of seconds of the scene and the scene explanation description can be displayed on the cover screen.

Information of the jersey number of the player who has taken the last shot is used when the position of the virtual camera is set in the viewer terminal 30. In the viewer terminal 30, the position of the virtual camera can be arbitrarily selected by the viewer from the following, for example. Basic: Arranged on an extension line connecting the goal and the ball; Bird's eye: Arranged at a position where the angle of view is wide in the upper rear of the ball; GK: Arranged at the viewpoint of the goalkeeper; Shooter: Arranged at the viewpoint of the player who shoots at the end of each scene.

The scene-reproduction start time and the scene duration time are time information indicating the highlight scene position in the motion-data time axis. Because it is format-converted motion data, the scene-playback start time is indicated by the format reference time, that is, the elapsed time from the beginning of the data.

Also, the operator terminal 40 may calculate the scene reproduction start time and the scene duration time of the corresponding highlight scene in the motion data on the basis of the scene time (IN point information, OUT point information) of the highlight 2D video, automatically set on the input screen, and allow the operator manually to make adjustments. The highlight 2D video (video including each highlight scene) may include video of other than players such as a coach or spectators or the like. However, because the motion data is data obtained by tracking the motions of players on the field, there may be no scene corresponding to the highlight 2D video in the motion data. Therefore, when the operator adjusts the scene-reproduction start time and the scene duration time, a scene suitable for generating the 3DCG video based on the motion data can be obtained.

Calculation of the scene-reproduction start time and the scene-duration time of the corresponding highlight scene in the motion data based on the highlight 2D video by the operator terminal 40 will be described. The scene time (IN point information, OUT point information) of the highlight 2D video is expressed by the elapsed time from the match-start time in the 2D video that is the source of the highlight 2D video. Conversely, the motion reference time used in the motion data is an elapsed time from Jan. 1, 2000 in the western calendar. Also, an elapsed time from the beginning of the motion data is set to 0 ms by format conversion. In this way, because the “highlight scene IN point information and OUT point information”, and the “motion data” reference time are different, the operator terminal 40 can automatically set the scene-reproduction start time and scene duration time of the highlight scene that corresponds to the motion data, by synchronizing the time.

For example, the operator terminal 40 first converts the match-start time information (date and time in the western calendar) included in the sport metadata into the motion reference time (elapsed time from Jan. 1, 2000 in the western calendar). Also, the operator terminal 40 acquires the motion-reference time (elapsed time from Jan. 1, 2000 of the western calendar) corresponding to the time (0 ms in the format-reference time) at the beginning of the format-converted motion data. By comparing these, the operator terminal 40 calculates the match-start time (that is, the elapsed time from the start (0 ms) of the motion data) at the format-reference time in the motion data. It is assumed that the motion data is acquired before the start of the match (for example, at kickoff), and the beginning the motion data is not necessarily the match-start time. As a result, the operator terminal 40 can calculate, from the position of the match-start time in the motion data, which position on the time axis in the motion data is the “IN point information, and OUT point information” indicated by the elapsed time from the start of the match, created when generating the highlight 2D video by the operator. The synchronization method described here is an example; embodiments are not limited thereto. Also, the time-synchronization processing can be executed by the editor AP operating in the operator terminal 40. Also, the time synchronization processing may be executed by the server 20B.

The second embodiment according to an aspect of the present disclosure was described above.

### 3. Modification Examples

### 3-1. First Modification Example

When creating the highlight metadata, the operator terminal 40 may automatically determine which goal is being attacked (attack situation) on the basis of which goal the position of the ball is close to in the last frame of each scene, and may automatically input the goal to the highlight metadata. When viewing on the viewer terminal 30, it is possible to display a scene in which the goal being attacked is typically captured in the angle of view, by arranging the virtual camera on the line of extension connecting the center of the goal being attacked and the position of the ball. Note that the automatic input of highlight metadata based on the analysis of each scene may be implemented by the server 20B.

### 3-2. Second Modification Example

Occurrence-event information such as who scored and when and who received a yellow card or the red card is included in the sport metadata of the match, but because it is assumed that the worker mainly manually inputs the sport metadata while watching the match in real-time video, the time information of the sport metadata may be deviated by about one minute before and after at the maximum as compared to the time when it occurred in the actual match.

Therefore, the server 20 (the server 20A or the server 20B) can analyze the motion data in which the occurrence event recorded in the sport metadata corresponds to one minute before and after the event occurrence time, and correct to a more accurate time. For example, in the case of the score information, the server 20 checks the position information of the ball data included in the motion data, and sets the time when the goal line is actually crossed as the time of the goal. Also, in the case of the yellow card or the red card, the server 20 sets the time when the motion of the hand of the referee indicates the card to the player as the time of the yellow card or the red card on the basis of the motion data of the referee included in the motion data. The server 20 rewrites the sport metadata at the time of the analysis result and stores that in the storage unit 230.

### 3-3. Third Modification Example

In the embodiment described above, it was described that the sport metadata of the match is generated by the worker B apparatus 14, but the present disclosure is not limited thereto. It is also possible that the server 20 (the server 20A or the server 20B) estimates the occurrence event on the basis of the motion data obtained from the worker A apparatus 12 (an example of an external apparatus) and automatically generates the sport metadata (an example of the event metadata). Because the motion data includes the time-series data of the position of the player and the position of the ball, the server 20 can determine (estimate) the occurrence of a specific event during the match, such as determining and the like the presence or absence of a score by comparing the position of the ball to the goal line, and generate the sport metadata.

### 3-4. Fourth Modification Example

Also, in the embodiment described above, it is assumed that the motion data and the sport metadata are distributed after the match, but the present disclosure is not limited thereto. The information-processing system may distribute in real time the motion data and the sport metadata acquired in real time during the match.

### 3-5. Fifth Modification Example

In the embodiment described above, it was described that the highlight metadata is generated on the basis of the operator's input or the like in the operator terminal 40, but the present disclosure is not limited thereto. The server 20B can generate the highlight metadata (particularly, the scene-start time and the scene-duration time) on the basis of the highlight 2D video. For example, the server 20B calculates the scene-reproduction start time and the scene-duration time of the corresponding highlight scene in the motion data on the basis of the scene time (IN point information, OUT point information) of the highlight 2D video. Synchronization of the scene time (IN point information, OUT point information) of the highlight 2D video and the reference time (format reference time) of the motion data is as described above.

### 4. Hardware Configuration

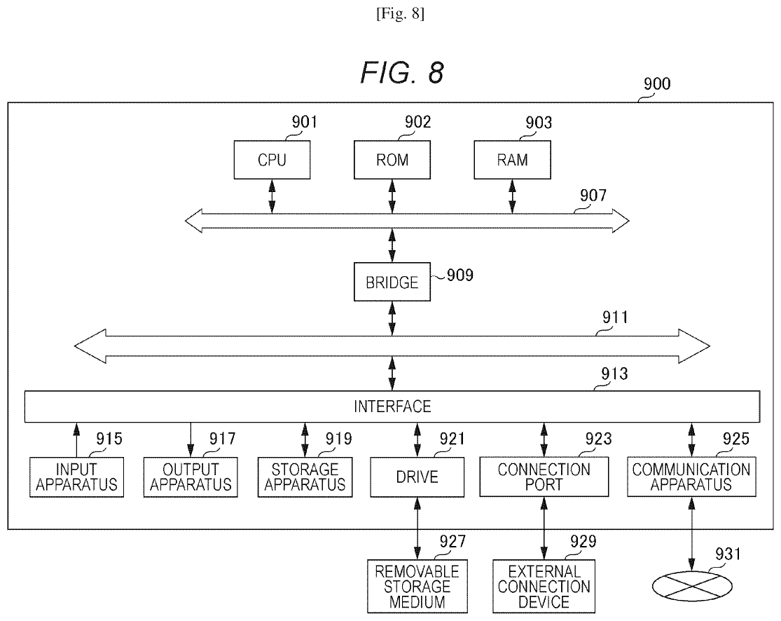

Next, a hardware configuration example of the information-processing apparatus 900 as an example of the server 20 (20A and 20B) according to an embodiment of the present disclosure will be described with reference to FIG. 8. FIG. 8 is a block diagram illustrating the hardware configuration example of the information-processing apparatus 900. Note that the server 20 (20A and 20B) does not necessarily have all of the hardware configurations illustrated in FIG. 8, and a part of the hardware configuration illustrated in FIG. 8 does not necessarily exist in the server 20 (20A and 20B). Also, the hardware configuration example illustrated in FIG. 8 can also be applied to the viewer terminal 30 or the operator terminal 40.

As illustrated in FIG. 8, the information-processing apparatus 900 includes a central processing unit (CPU) 901, a read-only memory (ROM) 902, and a random-access memory (RAM) 903. Also, the information-processing apparatus 900 may include a host bus 907, a bridge 909, an external bus 911, an interface 913, an input apparatus 915, an output apparatus 917, a storage apparatus 919, a drive 921, a connection port 923, and a communication apparatus 925. The information-processing apparatus 900 may have a processing circuit called a digital-signal processor (DSP) or an application-specific integrated circuit (ASIC) instead of or in combination with the CPU 901.

The CPU 901 serves as an arithmetic processing apparatus and a control apparatus and controls overall operation in the information-processing apparatus 900 or a part thereof according to various programs recorded in the ROM 902, the RAM 903, the storage apparatus 919, or a removable recording medium 927. The ROM 902 stores programs and calculation parameters and the like used by the CPU 901. The RAM 903 temporarily stores a program used in execution by the CPU 901, and parameters that change as appropriate during the execution, and the like. The CPU 901, the ROM 902, and the RAM 903 are mutually connected by the host bus 907 configured by an internal bus such as a CPU bus or the like. Furthermore, the host bus 907 is connected to the external bus 911 such as a peripheral component interconnect/interface (PCI) bus via the bridge 909.

The input apparatus 915 is, for example, an apparatus such as a button or the like, operated by the user. The input apparatus 915 may include a mouse, a keyboard, a touch panel, switches, and levers, and the like. Also, the input apparatus 915 may also include a microphone that detects voice of the user. The input apparatus 915 may be, for example, a remote-control apparatus utilizing infrared light or other radio waves, or may be an external connection device 929 such as a mobile phone or the like that corresponds to operation of the information-processing apparatus 900. The input apparatus 915 includes an input-control circuit that generates and outputs input signals to the CPU 901 on the basis of information inputted by the user. By operating the input apparatus 915, the user inputs various types of data or gives an instruction to perform a processing operation, to the information-processing apparatus 900. Also, the input apparatus 915 may include an imaging apparatus. The imaging apparatus captures, for example, a motion of a hand of the user, or a finger of the user, and the like. At this time, a pointing position may be determined according to the motion of the hand and a direction of the finger.

The output apparatus 917 is configured of an apparatus that can visually or audibly notify the user of acquired information. The output apparatus 917 may be, for example, a display apparatus such as a liquid crystal display (LCD) or an organic electroluminescence (EL) display, or an audio output apparatus such as a speaker and headphones, and the like. Also, the output apparatus 917 may include a plasma-display panel (PDP), a projector, a hologram, and a printer, and the like. The output apparatus 917 outputs a result obtained by processing of the information-processing apparatus 900 as a text or a video such as an image, or outputs the result as audio in the form of a voice or sound. Also, the output apparatus 917 may include a light or the like in order to brighten the surroundings.

The storage apparatus 919 is a data storage apparatus configured as an example of a storage unit of the information-processing apparatus 900. The storage apparatus 919 includes, for example, a magnetic storage apparatus such as a hard disk drive (HDD), a semiconductor storage apparatus, an optical storage apparatus, and a magneto-optical storage apparatus, or the like. The storage apparatus 919 stores programs and various data executed by the CPU 901, and various data acquired from the outside, and the like.

The drive 921 is a reader/writer for the removable recording medium 927, such as a magnetic disk, an optical disk, a magneto-optical disk, or a semiconductor memory, and is built in or externally attached to the information-processing apparatus 900. The drive 921 reads information recorded in the mounted removable recording medium 927, and outputs to the RAM 903. Also, the drive 921 writes records in the mounted removable recording medium 927.

A connection port 923 is a port for directly connecting a device to the information-processing apparatus 900. The connection port 923 may be, for example, a universal serial bus (USB) port, an IEEE1394 port, or a small computer system interface (SCSI) port, or the like. Furthermore, the connection port 923 may be an RS-232C port, an optical audio terminal, or a high-definition multimedia interface (HDMI (registered trademark)) port, or the like. By connecting the external connection device 929 to the connection port 923, various kinds of data may be exchanged between the information-processing apparatus 900 and the external connection device 929.

A communication apparatus 925 is, for example, a communication interface including a communication apparatus for connecting to a network 931, or the like. The communication apparatus 925 can be, for example, a communication card for a wired or wireless local area network (LAN), Bluetooth (registered trademark), or wireless USB (WUSB), or the like. Also, the communication apparatus 925 may be a router for optical communication, a router for asymmetric digital subscriber line (ADSL), or a modem for various communication, or the like. The communication apparatus 925 transmits and receives, for example, signals and the like to and from the Internet and other communication devices using a predetermined protocol such as TCP/IP. Also, the network 931 connected to the communication apparatus 925 is a network connected by wire or wirelessly and is, for example, the Internet, a home LAN, infrared communication, radio wave communication, or satellite communication, or the like.

### 5. Supplement

Embodiments of the present disclosure were described above in detail with reference to the accompanying drawings, but the present technology is not limited to such examples. It is apparent that a person having ordinary knowledge in the technical field of the present disclosure can devise various change examples or modification examples within the scope of the technical idea described in the claims, and it will be naturally understood that they also belong to the technical scope of the present disclosure.

For example, it is also possible to create one or more computer programs for causing hardware such as the CPU, the ROM, and the RAM and the like built into the server 20A, the server 20B, the viewer terminal 30, or the operator terminal 40 to exhibit the functions of the server 20A, the server 20B, viewer terminal 30, or the operator terminal 40. Also, a computer-readable storage medium that stores the one or more computer programs is also provided.

Also, the effects described in the present specification are not restrictive. That is, the technology according to an aspect of the present disclosure can exhibit other effects apparent to those skilled in the art from the description of the present specification, in addition to the effect described above or instead of the effect described above.

Note that the present technology can also have the following configuration.
(1) An information processing apparatus including:
circuitry configured to:
receive, from a first apparatus, motion data captured in an event;
receive, from a second apparatus, event metadata related to the event; and
transmit the motion data and the event metadata to a user apparatus.
(2) The information processing apparatus according to (1), wherein the circuitry is further configured to:
transmit the motion data to the user apparatus in a streaming format; and
transmit the event metadata to the user apparatus in a download format.
(3) The information processing apparatus according to any one of (1) or (2), wherein the motion data is streamed by the user apparatus and the event metadata is downloaded by the user apparatus.
(4) The information processing apparatus according to any one of (1) to (3), wherein a virtual avatar or an object generated based on the motion data is displayed with the event metadata by the user apparatus.
(5) The information processing apparatus according to any one of (1) to (4),
wherein the motion data includes data of a participant or an object in the event, and
a video of a virtual space including a virtual avatar of the participant or the object is displayed by the user apparatus by using the motion data and 3D models of the participant or the object received from the information processing apparatus in advance of the motion data.
(6) The information processing apparatus according to any one of (1) to (5),
wherein the motion data is synchronized with the event metadata.
(7) The information processing apparatus according to any one of (1) to (6).
wherein the motion data and the event metadata are synchronized with reference to a reference time used for the motion data.
(8) The information processing apparatus according to any one of (1) to (7),
wherein the synchronization includes
calculating a start timing of the event in the motion data on a basis of information regarding a start date and time of the event included in the event metadata, and
displaying the event metadata based on an elapsed time from the start timing in the motion data,
converting the start date and time information of the start timing into an elapsed time from the reference time used for the motion data,
determining the start timing in the motion data based on the conversion time, and converting the start timing of the motion data into the elapsed time from the start timing in the motion data.
(9) The information processing apparatus according to any one of (1) to (8),
wherein the synchronization is implemented in advance in the information processing apparatus and transmitted to the user apparatus.
(10) The information processing apparatus according to any one of (1) to (9),
wherein the event metadata includes information regarding a start date and time of the event, information regarding an occurrence event and a time of the occurrence event in the event, or information relating to a participant in the event.
(11) The information processing apparatus according to any one of (1) to (10),
wherein motion data includes data of an object in the event, data of a participant in the event, data of a position of the object, data of height of the position of the object from the ground, data of three-dimensional skeleton position of the participant, or data of height of the three-dimensional skeleton position of the participant from the ground.
(12) The information processing apparatus according to any one of (1) to (11),
wherein the circuitry is further configured to:
receive, from the first apparatus, sound data captured in the event.
(13) The information processing apparatus according to any one of (1) to (12),
wherein the circuitry is further configured to:
receive highlight metadata indicating time information of a highlight scene in the motion data that is generated on a basis of time information of the highlight scene.
(14) The information processing apparatus according to any one of (1) to (13),
wherein the time information of the highlight scene includes information indicating a scene-reproduction start time and scene duration time of the highlight scene in the motion data.
(15) The information processing apparatus according to any one of (1) to (14),
wherein the scene-reproduction start time is indicated by an elapsed time from a start timing of the motion data.
(16) The information processing apparatus according to any one of (1) to (15),
wherein the circuitry is further configured to:
transmit the highlight metadata to the user apparatus.
(17) The information processing apparatus according to any one of (1) to (16),
wherein the circuitry is further configured to:
transmit the motion data and the event metadata to an operator terminal; and
receive, from the operator terminal, the highlight metadata generated based on the transmitted motion data and event metadata.
(18) The information processing apparatus according to any one of (1) to (17),
wherein a virtual avatar or object generated based on the highlight scene is displayed with the highlight metadata by the user apparatus.
(19) The information processing apparatus according to any one of (1) to (18),
wherein the highlight metadata includes scene reproduction start time and scene duration time of the highlight scene.
(20) The information processing apparatus according to any one of (1) to (19), wherein a start date and time information of a start timing of the event is converted into an elapsed time from a reference time used for the motion data, and
a time at a beginning of the motion data is compared with the elapsed time to calculate an elapsed time from a start of the motion data.
(21) An information processing method including:
receiving, from a first apparatus, motion data captured in an event;
receiving, from a second apparatus, event metadata related to the event; and
transmitting the motion data and the event metadata to a user apparatus.
(22) A non-transitory computer-readable medium having embodied thereon a program, which when executed by a computer causes the computer to execute an information processing method, the method including:
receiving, from a first apparatus, motion data captured in an event;
receiving, from a second apparatus, event metadata related to the event; and
transmitting the motion data and the event metadata to a user apparatus.
(23) An information processing system including:
circuitry configured to
receive, from a first apparatus, motion data captured in an event,
receive, from a second apparatus, event metadata related to the event,
initiate a displaying of a virtual object on a display, based on the motion data, and initiate a displaying of information on the display, based on the event metadata.
(24) The information processing system according to (23),
wherein the motion data and the event metadata are received via a server.
(25) The information processing system according to any one of (23) or (24),
wherein the motion data is acquired by tracking the object in the event.
(26) The information processing system according to any one of (23) to (25),
wherein the object includes a human.
(27) The information processing system according to any one of (23) to (26),
wherein the circuitry is further configured to: synchronize the motion data and the event metadata.
(28) Information displayed on a screen including
motion data captured in an event and event metadata related to the event displayed on the screen,
wherein the motion data and event metadata are generated by receiving the motion data and the event metadata from an information processing apparatus that receives the motion data from a first apparatus and receives the event metadata from a second apparatus.
(B1)
An information-processing apparatus including:
a control unit that implements
a process of obtaining a motion data obtained by tracking a motion of a target during an event and an event metadata at least including a time-series data related to a situation of the event; and
a process of transmitting the motion data and the event metadata to a user terminal that performs: a control to display a virtual object of the target in a virtual space on the basis of the motion data, and a display control based on the event metadata of a display screen on which the virtual object is displayed,
the motion data and the event metadata being generated in different apparatuses.
(B2)
The information-processing apparatus according to (B1) above, in which the event is a match.
(B3)
The information-processing apparatus according to (B2) above, in which the control unit
obtains the motion data from a first apparatus, and
obtains the event metadata from a second apparatus different from the first apparatus.
(B4)
The information-processing apparatus according to (B2) above, in which the control unit
obtains the motion data from an external apparatus, and
generates the event metadata on the basis of the motion data.
(B5)
The information-processing apparatus according to any one of (B2) to (B4) above, in which
the event metadata includes an information of a match start date and time and a timeseries data indicating an occurrence event in the match and an occurrence time.
(B6)
The information-processing apparatus according to (B5) above, in which the control unit implements a process of adjusting a deviation of the occurrence time based on the motion data.
(B7)
The information-processing apparatus according to (B5) or (B6) above, in which the occurrence event includes a score and various warnings by a referee.
(B8)
The information-processing apparatus according to any one of (B5) to (B7) above, in which
the occurrence event is estimated on the basis of the motion data.
(B9)
The information-processing apparatus according to any one of (B2) to (B8) above, in which
the event metadata further includes an information related to a player.
(B10)
The information-processing apparatus according to any one of (B2) to (B9) above, in which
the motion data includes a time-series data of a skeleton position of each player and a time-series data of a position of a ball.
(B11)
The information-processing apparatus according to any one of (B2) to (B10) above, in which
the control unit implements a process of converting the motion data into a distribution format and transmitting the motion data, which has been converted, to the user terminal together with the event metadata.
(B12)
The information-processing apparatus according to (B11) above, in which
a reference time used in the distribution format is applied to the motion data converted into the distribution format.
(B13)
The information-processing apparatus according to any one of (B2) to (B12) above, in which
the control unit implements a process of further obtaining a highlight metadata that is an information related to a highlight scene of the match, and transmitting the highlight metadata to the user terminal together with the motion data and the event metadata.
(B14)
The information-processing apparatus according to (B13) above, in which the highlight metadata includes an information indicating a start time and a duration time of each highlight scene of the motion data.
(B15)
The information-processing apparatus according to (B13) or (B14) above, in which the reference time of the highlight metadata corresponds to a reference time used in the distribution format into which the motion data is converted.
(B16)
The information-processing apparatus according to any one of (B13) to (B15) above, in which
the highlight metadata is generated in an apparatus different from an apparatus that generates the motion data and an apparatus that generates the event metadata.
(B17)
The information-processing apparatus according to (B16) above, in which
the control unit transmits a data obtained by converting the motion data into the distribution format and the event metadata to an apparatus that generates the highlight metadata, and receives the highlight metadata from the apparatus.
(B18)
The information-processing apparatus according to any one of (B13) to (B17) above, in which
the highlight metadata includes an information indicating an attack situation of each highlight scene as an information used when an arrangement of a virtual camera in the virtual space is determined at the user terminal.
(B19)
An information-processing method including:
obtaining by a processor a motion data obtained by tracking a target motion during an event and an event metadata at least including a time-series data related to a situation of the event; and
implementing by the processor a process of transmitting the motion data and the event metadata to a user terminal in which the user terminal implementing a control of displaying a virtual object of the target in a virtual space on the basis of the motion data and a display control based on the event metadata in a display screen where the virtual object is displayed, the motion data and the event metadata being generated in different apparatuses.
(B20)
A program that causes a computer to function as a control unit to implement:
a process of obtaining a motion data obtained by tracking a target motion during an event and an event metadata including at least a time-series data related to a situation of the event; and
a process of transmitting the motion data and the event metadata to a user terminal in which the user terminal implements a control of displaying the target virtual object in a virtual space on the basis of the motion data and a display control based on the event metadata on a display screen on which the virtual object is displayed, the motion data and the event metadata being generated in different apparatuses.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1A, 1B Information-processing system
11a Camera
11b Microphone
12 Worker A apparatus
13 Operation-input apparatus
14 Worker B apparatus
20A, 20B Server
210 Communication unit
220A, 220B Control unit
221 Distribution-format conversion unit
222 Data-storage control unit
223 Distribution-control unit
224 Highlight-metadata acquisition unit
30 Viewer terminal
40 Operator terminal

1. An information processing apparatus comprising:
circuitry configured to:
receive, from a first apparatus, motion data captured in an event;
receive, from a second apparatus, event metadata related to the event; and
transmit the motion data and the event metadata to a user apparatus.

2. The information processing apparatus according to claim 1,
wherein the circuitry is further configured to:
transmit the motion data to the user apparatus in a streaming format; and
transmit the event metadata to the user apparatus in a download format.

3. The information processing apparatus according to claim 1,
wherein the motion data is streamed by the user apparatus and the event metadata is downloaded by the user apparatus.

4. The information processing apparatus according to claim 1,
wherein a virtual avatar or an object generated based on the motion data is displayed with the event metadata by the user apparatus.

5. The information processing apparatus according to claim 1,
wherein the motion data includes data of a participant or an object in the event, and
a video of a virtual space including a virtual avatar of the participant or the object is displayed by the user apparatus by using the motion data and 3D models of the participant or the object received from the information processing apparatus in advance of the motion data.

6. The information processing apparatus according to claim 1,
wherein the motion data is synchronized with the event metadata.

7. The information processing apparatus according to claim 6,
wherein the motion data and the event metadata are synchronized with reference to a reference time used for the motion data.

8. The information processing apparatus according to claim 7,
wherein the synchronization includes
calculating a start timing of the event in the motion data on a basis of information regarding a start date and time of the event included in the event metadata,
displaying the event metadata based on an elapsed time from the start timing in the motion data,
converting the start date and time information of the start timing into an elapsed time from the reference time used for the motion data,
determining the start timing in the motion data based on the conversion time, and
converting the start timing of the motion data into the elapsed time from the start timing in the motion data.

9. The information processing apparatus according to claim 7,
wherein the synchronization is implemented in advance in the information processing apparatus and transmitted to the user apparatus.

10. The information processing apparatus according to claim 1,
wherein the event metadata includes information regarding a start date and time of the event, information regarding an occurrence event and a time of the occurrence event in the event, or information relating to a participant in the event.

11. The information processing apparatus according to claim 1,
wherein motion data includes data of an object in the event, data of a participant in the event, data of a position of the object, data of height of the position of the object from the ground, data of three-dimensional skeleton position of the participant, or data of height of the three-dimensional skeleton position of the participant from the ground.

12. The information processing apparatus according to claim 1,
wherein the circuitry is further configured to:
receive, from the first apparatus, sound data captured in the event.

13. The information processing apparatus according to claim 1,
wherein the circuitry is further configured to:
receive highlight metadata indicating time information of a highlight scene in the motion data that is generated on a basis of time information of the highlight scene.

14. The information processing apparatus according to claim 13,
wherein the time information of the highlight scene includes information indicating a scene-reproduction start time and scene duration time of the highlight scene in the motion data.

15. The information processing apparatus according to claim 14,
wherein the scene-reproduction start time is indicated by an elapsed time from a start timing of the motion data.

16. The information processing apparatus according to claim 13,
wherein the circuitry is further configured to:
transmit the highlight metadata to the user apparatus.

17. The information processing apparatus according to claim 13,
wherein the circuitry is further configured to:
transmit the motion data and the event metadata to an operator terminal; and
receive, from the operator terminal, the highlight metadata generated based on the transmitted motion data and event metadata.

18. The information processing apparatus according to claim 13,
wherein a virtual avatar or object generated based on the highlight scene is displayed with the highlight metadata by the user apparatus.

19. The information processing apparatus according to claim 13,
wherein the highlight metadata includes scene reproduction start time and scene duration time of the highlight scene.

20. The information processing apparatus according to claim 13, wherein a start date and time information of a start timing of the event is converted into an elapsed time from a reference time used for the motion data, and
a time at a beginning of the motion data is compared with the elapsed time to calculate an elapsed time from a start of the motion data.

21. An information processing method comprising:
receiving, from a first apparatus, motion data captured in an event;
receiving, from a second apparatus, event metadata related to the event; and
transmitting the motion data and the event metadata to a user apparatus.

22. A non-transitory computer-readable medium having embodied thereon a program, which when executed by a computer causes the computer to execute an information processing method, the method comprising:
receiving, from a first apparatus, motion data captured in an event:
receiving, from a second apparatus, event metadata related to the event; and
transmitting the motion data and the event metadata to a user apparatus.

23. An information processing system comprising:
circuitry configured to
receive, from a first apparatus, motion data captured in an event,
receive, from a second apparatus, event metadata related to the event,
initiate a displaying of a virtual object on a display, based on the motion data, and
initiate a displaying of information on the display, based on the event metadata.

24. The information processing system according to claim 23,
wherein the motion data and the event metadata are received via a server.

25. The information processing system according to claim 23,
wherein the motion data is acquired by tracking the object in the event.

26. The information processing system according to claim 25,
wherein the object includes a human.

27. The information processing system according to claim 23,
wherein the circuitry is further configured to: synchronize the motion data and the event metadata.

28. Information displayed on a screen comprising
motion data captured in an event and event metadata related to the event displayed on the screen,
wherein the motion data and event metadata are generated by receiving the motion data and the event metadata from an information processing apparatus that receives the motion data from a first apparatus and receives the event metadata from a second apparatus.
